(19) United States
(12) Patent Application Publication
(10) Pub. No.: US 2013/0041085 A1
(43) Pub. Date: Feb. 14, 2013

(54) TEMPORARY PROTECTIVE COATING COMPOSITION

(71) Applicant: Peter James Bedwell, Lincoln (GB)

(72) Inventor: Peter James Bedwell, Lincoln (GB)

(73) Assignee: ATAC UK LTD, Lincoln (GB)

(21) Appl. No.: 13/583,325

(22) PCT Filed: Mar. 8, 2011
(86) PCT No.: PCT/GB2011/050458

§ 371 Date: Sep. 7, 2012

(30) Foreign Application Priority Data
Mar. 12, 2010 (GB) 1004148.1

(51) Int. Cl. C09D 133/06; C08K 5/101; C08K 5/11; C08F 220/10

(52) U.S. Cl. 524/275; 524/563; 524/310

(57) ABSTRACT

A temporary protective coating composition comprises a thermoplastic polymer which is forms a flowable liquid at a temperature of from 120° C. to 200° C. and which can be applied to an article to form a continuous film thereon which when solidified adheres to the article, but which may be removed manually from the article as a substantially continuous film. Preferably, the composition comprises:

more than 75% by weight of an ethylene vinyl acetate copolymer (EVA) with a melt flow index (MFI) less than 400; and

from 1% to less than 25% by weight of wax.

The composition is suitably applied by a slot coater,

### PRIORITY CLAIM

This Application is a U.S. national stage filing claiming the benefit of priority from PCT Application No. PCT/GB2011/050458, filed on Mar. 8, 2011, which claims foreign priority from GB Application No, 1004148.1, filed on Mar. 12, 2010, the contents of which are incorporated herein by reference in the entirety.

### FIELD OF THE INVENTION

This invention relates to a temporary protective coating composition and to a method of providing a temporary protective coating on an article.

### BACKGROUND TO THE INVENTION

Peelable temporary coatings are used on a variety of articles to provide protection during transit and installation, for example glass, double-glazed windows, doors, PVC or aluminium profiles, kitchen units, baths, sinks, and various metal surfaces, When the protective coating is no longer required, it is simply stripped off by hand and disposed of.

Conventionally, such coatings have been applied in solution form, typically by spraying. Organic solvent-based coatings suffer from the disadvantages that they require a long time to dry, and the evaporation of solvents can present a health risk, as well as a fire and explosion hazard, requiring carefully controlled conditions for the spraying and drying, adding significantly to the cost of using such systems.

To overcome some of these problems, water-based coatings have been developed. While these overcome the fire/explosion hazard, and to a large extent the risk of adverse health effects, such coatings typically need to be applied relatively thickly, and as water evaporates slowly the drying times can be extended, typically about one hour. Forced drying can be applied, but this requires zoned drying ovens, which are expensive to construct and to operate, and occupy a large amount of space. Thus, while water-based compositions are very useful in external applications where drying time is not important, they are wholly unsuitable for production line environments where speed is important.

Most recently, new systems are being developed which employ radiation curing. Such systems require an application station, where the coating is applied as a cold liquid, and a curing station where the coating is irradiated with powerful UV radiation to cure it rapidly. The disadvantages of this system are, however, that the raw materials are relatively expensive, there are irritant hazards, the use of UV radiation sources requires protective shielding to prevent personnel being exposed to the radiation, and the coating materials are thermosetting, and are therefore not recyclable. This means that the stripped coatings have to be disposed of in landfill, which is costly and undesirable environmentally.

The present invention seeks to provide a hot-melt composition which avoids or significantly reduces the disadvantages of the existing compositions. Hot-melt compositions are known from, for example, GB1361506, which discloses a removable coating including 20-80% by weight of a high molecular weight copolymer of ethylene with 12-45% by weight of one or more comonomers chosen from vinyl acetate and others, and 80-20% of a low molecular weight copolymer of ethylene and 5-30% by weight of one or its more comonomers. The coatings are applied as a melt by dipping. GB1260486 discloses removable coatings sprayed on to a surface as a melt. The composition includes a film-forming ethylene/vinyl acetate copolymer. GB1048993 discloses a blend of paraffin wax with an ethylene/vinyl acetate copolymer, again applied by dipping. In order to permit the application by spraying or dipping, the viscosity has to be kept low, and it has been found that in practice this means that the resultant hardened coating cannot readily be stripped off as a film, being either too brittle to strip as a film, or lacking sufficient film strength to permit removal as a continuous sheet.

### SUMMARY OF THE INVENTION

According to the invention, there is provided a temporary protective coating composition comprising a thermoplastic polymer which is forms a flowable liquid at a temperature of from 120° C. to 200° C. and which can be applied to an article to form a continuous film thereon which when solidified adheres to the article, but which may be removed manually from the article as a substantially continuous film.

The thermoplastic polymer is suitably an ethylene vinyl acetate copolymer (EVA), but it may be possible to use other polymers, such as atactic poly alpha olefins or styrene butadiene copolymers.

Preferably, the composition comprises:

more than 75% by weight of an ethylene vinyl acetate copolymer (EVA) with a melt flow index (MFI) less than 400; and

from 1% to less than 25% by weight of wax.

Preferably, the EVA comprises from 14-60% by weight of vinyl acetate, and more preferably at least 18%. In a preferred embodiment, the content of vinyl acetate in the EVA is 28% by weight. The MFI of the EVA is preferably less than 200, more preferably around 100. The composition preferably comprises 80% by weight EVA, and may have 5 to 20%, more preferably 15-19%, by weight of the modified wax. Castor oil, hydrogenated castor oil, or a mixture of these, may be added, preferably in an amount of 1-10% by weight of the composition, preferably 5%.

Antioxidants and UV stabilisers may also be incorporated, typically from 0.1% to 1% by weight of the composition.

The wax is incorporated to reduce molecular weight adhesion and allow better flow. The wax is suitably a vinyl acetate modified wax, which preferably comprises at least 14% vinyl acetate. Alternatively, the wax may be selected from ethylene waxes, Fischer Tropsch, crystalline and microcrystalline waxes, paraffin chlorinated waxes and bees wax.

Alternatively or additionally, resins may be blended with the polymer in the composition, such as rosins, rosin esters, hydrocarbons, synthetic alpha methyl styrene, styrene, phenolic resins and polyterpene, the content being selected so as to achieve optimum viscosity while not increasing adhesion of the coating to the article to hinder its stripping from the article when no longer required.

Oils and plasticisers may be added.

The invention also provides a method of providing a temporary protective coating on an article, comprising melting a composition according to the invention, applying the molten composition to the surface of the article, and allowing the composition to solidify to form a peelable film on said article. The application of the molten composition is suitably by extruding a film of the composition on to the article.

The advantages of the composition and method of the invention are:

1. The coating only requires one application station, so the equipment is cheaper than that required for solvent- or water-based systems or for radiation-cured compositions;

2. The stripped film, being thermoplastic, is readily reusable, or recyclable for other uses, whereas the radiation-cured and water-based compositions are not;

3. The hazards associated with solvent-based or radiation-cured compositions are avoided;

4. The coating hardens within seconds, whereas water- and solvent-based materials can take up to an hour to cure; and

5. The raw material costs are significantly lower than with other compositions.

### DETAILED DESCRIPTION OF THE INVENTION

### Example

A hot melt composition is formulated with the following:

| | |
|---|---|
| Ethylene/vinyl acetate copolymer with 28% by weight | 80% |
| vinyl acetate and a melt flow index (MFI) of 100 | |
| Vinyl actetate modified wax (AC 400) with 14% vinyl acetate | 15% |
| Castor oil | 2.5% |
| Hydrogenated castor oil | 2.5% |

(percentages by weight)

The high polymer content and relatively low WI mean that the composition will be very tough and elastic to produce a peelable coating, but the resultant viscosity will be such that application cannot be by dipping or spraying. Extrusion using a slot coater is therefore required. Reducing vinyl acetate content will reduce viscosity, which may assist application, but to balance this are reduced adhesion and greater stiffness. The composition set out above is sufficiently strong and elastic to permit it to be stripped by hand from very large surface areas, such as a large planar sheet of glass, while also enabling it to follow contours closely and adhere to provide a durable surface which can be left in place for extended periods, for example up to one year, to protect the surface of the article from dirt and dust, paint, minor knocks and scratches and the like. Once the need to protect the surface has passed, the protective coating can simply be stripped by hand. The removed film may then be disposed of as non-hazardous waste, for example in landfill, but it is preferably recycled by re-melting and incorporation into further coatings.

A UV stabiliser may be needed to enable the coating to remain strong and flexible after prolonged exposure to sunlight (and extremes of weather). A typical UV stabiliser is TINUVIN®. Hindered amine light stabilisers, nano pigments and zinc oxide compounds may be incorporated. An antioxidant may be incorporated to protect the product both in the molten and applied state, and such systems as BHT and BHT/phosphine blends may be used.

1. A temporary protective coating composition comprising a thermoplastic polymer which forms a flowable liquid at a temperature of from 120° C. to 200° C. and which can be applied to an article to form a continuous film thereon which when solidified adheres to the article, but which may be removed manually from the article as a substantially continuous film.

2. A composition according to claim 1, comprising:
more than 60% by weight of an ethylene vinyl acetate copolymer (EVA) with a melt flow index (MF) less than 400; and
less than 40% by weight of wax.

3. A composition according to claim 2, comprising more than 75% by weight of the EVA.

4. A composition according to claim 3, wherein the EVA comprises 14 to 60% by weight of vinyl acetate.

5. A composition according to claim 4, wherein the EVA comprises at least 18% by weight of vinyl acetate.

6. A composition according to claim 5, wherein the EVA comprises 28% by weight of vinyl acetate.

7. A composition according to claim 2, wherein the MFI of the EVA is less than 200.

8. A composition according to claim 5, wherein the MFI is 100.

9. A composition according to claim 2, wherein the wax is a vinyl acetate modified wax.

10. A composition according to claim 9, wherein the vinyl acetate modified wax comprises 14% vinyl acetate.

11. A composition according to claim 2, comprising 80% by weight EVA.

12. A composition according to claim 11, comprising 15-19% by weight of a vinyl acetate modified wax.

13. A composition according to claim 12, including castor oil, hydrogenated castor oil, or a mixture of these.

14. A composition according to claim 13, wherein the castor oil and/or hydrogenated castor oil comprises 1-20% by weight of the composition.

15. A composition according to claim 14, wherein the castor oil and/or hydrogenated castor oil comprises less than 15% by weight of the composition.
